(19) United States
(12) Patent Application Publication
(10) Pub. No.: US 2012/0189282 A1
(43) Pub. Date: Jul. 26, 2012

(54) Generation and Management of Video Blogs

(75) Inventors: Christopher W. Wyatt, Irving, TX (US); Mark A. Harwell, Irving, TX (US); Ryland M. Reed, Irving, TX (US)

(73) Assignee: Youtoo Technologies, Inc., Irving, TX (US)

(21) Appl. No.: 13/198,842

(22) Filed: Aug. 5, 2011

Related U.S. Application Data
(63) Continuation of application No. 13/013,775, filed on Jan. 25, 2011.

(51) Int. Cl. H04N 5/93; H04N 7/16; H04N 5/445

(52) U.S. Cl. 386/278; 725/37; 725/25; 386/E05.003

(57) ABSTRACT

Disclosed are various automated methods and apparatus for scheduling and distributing user-generated content as part of or during a television program that is being distributed as part of a linear programming line-up of a television network. Users upload user-generated content through, for example, a mobile application on smart phone, a web site, or through an online service such as a social media network, and are given the opportunity to schedule transmission of uploaded content during transmission of television network linear programming by purchasing a time slot or bidding on a time slot through an auction process using real or virtual currency, including points, credits or other form of virtual currency, or being awarded or given a time slot. An automated process obtains available time slots and schedules user generated content for transmission by the network as part of previously scheduled, linear programming.

### BACKGROUND

It has become relatively easy for individuals and groups of individuals to take digital photographs and record video, and to distribute this content to others over the Internet or other data networks. Such content is referred to as being “user generated” content. Still and video cameras, which are now common features on mobile phones, can be used to take photographs and to record videos that are immediately available for sharing with others through a multi-media messaging service or email, video file sharing sites, social network and similar services on the Internet that publish (to selected individuals or groups, or to everyone) or otherwise make available the photographs and video over the Internet. Some dedicated cameras and storage cards now have wireless or network connectivity and video to be uploaded to remote servers for sharing. Individuals or “consumers” distribute their photos and videos by uploading them to web-based services that publish them for friends, family, social or business contacts or anyone with access to the Internet to view. When user-generated content is uploaded or shared for a specific purpose, such as for example, in response to a request for a certain type of content, it may be referred to as crowd-sourced content.

Most consumer equipment capable of capturing photos or video is now able to do so in high definition. High definition video cameras are now the norm. Inexpensive, easy-to-use computer application programs allow individuals to edit photographs, videos and other graphics into a single work with nearly professional results, and to render the resulting work or “content” in standard formats for playback on a wide range of devices. Services for sharing user-generated video, photographs, and music abound on the Internet. For example, a number of video sharing sites allow people to upload, encode and share videos on the web.

On the other hand, most people still view professionally produced television programs (“programs”) and motion pictures (“movies”) using traditional television services. Programs are typically distributed to traditional television service providers by so-called “television networks,” who possess the legal rights necessary to distribute the programs, and who are sometimes also involved in producing the programming. Those who provide transmission services for television, and provide television service to viewers, are referred to as “carriers.” Most television networks “sell” short periods of time during the programming for transmission of advertising, known as “commercials,” “advertisements,” “ads” or “ ad spots,” that promote businesses or programming on the network. These time slots can also be used for transmission of public service announcements.

Television transmission or distribution systems used by traditional carriers of television programming include terrestrial broadcast stations, satellite television, and cable television systems, as well as telecom delivery network services such as VDSL and FiOS offered over broadcast telecommunication or data networks, whose operators provide television services similar to what are offered by cable and satellite television service providers. However, standards have been formulated, or are in the process of being formulated, for using Internet protocols and the public Internet to distribute television programming using “live” IP-multicast or IP unicast streams that can be received by anyone with any type of broadband data connection to the Internet.

Though some television programs are available over the Internet and traditional carriers on an on-demand basis, traditional television programming for a television network is linear, meaning that programs—an episode of a television series, a news program, or a movie, for example—are scheduled so that they are transmitted sequentially, according to a predefined schedule, to carriers for transmission over their systems for substantially contemporaneous receipt by their subscribers or, in the case of terrestrial broadcast stations, by those who receive their broadcast signal. The programming schedule is often planned in advance.

### SUMMARY

The invention, as set forth in the appended claims, pertains generally to, or can be used in connection with, implementing one or more aspects of automated methods and apparatus for receiving and displaying or performing user-generated content as part of or during a television program that is being distributed as part of a linear programming line-up. Examples of different embodiments of such methods and apparatus are described below.

In one embodiment, an automated service obtains information on one or more time slots within one or more television (TV) programs for each of one or more television networks from one or more servers used by the networks for creating and/or storing the linear TV programming schedule. A user is presented with interface, for example, through a web browser or an application, to an online service that permits the user to upload user-generated, crowd-sourced content, and obtain a time slot in a TV program being transmitted to a television audience.

In another embodiment, users bid on one or more predetermined time slots within linear television network programming for transmission of the uploaded content. One technical advantage of the embodiment includes the ability to obtain value for an advertising time slot that is of a higher amount than a commercial advertiser might otherwise be willing to pay, or has already agreed to pay, for the same time slot by setting a reserve price for the auction process. The auction process may determine a more accurate value for a particular time slot than the conventional determination based on viewership ratings, as is typically done. In an alternative embodiment, a time slot can be awarded to one of several users requesting the slot on a promotional basis or in exchange for credits or some other virtual currency that a user has earned or otherwise possesses.

According to another embodiment, only members of a group or organization, or that are members of a predetermined on-line community, utilize a web interface in order to arrange for transmission of uploaded user-generated or crowd-sourced content during at least a portion of linear television programming. Optionally, this programming may target that group, organization or others who have or share similar affinities (each an “affinity” group). For example, an interface for enabling a user to upload such user-generated content and/or arrange for user-generated content that has been uploaded to be transmitted during the targeted or affinity television programming, can be made available through a web site, on-line social networking or other online service for that group or organization. Optionally, the interface can be, for example, specially adapted or configured to enable the user only to arrange for display or performance of that user's content during only programming associated with anyone or all groups or organizations with which the user is affiliated. A computer implemented method and apparatus is thus provided for enabling a group or organization to create compelling content or messages that it can distribute to its members through a particular linear television program targeted to the members of the group.

In another embodiment, a user is able to create user-generated content and selectively distribute that message to web users, mobile device users, and television viewers. A user may or may not be required to pay a fee for the distribution of this message through one, some, or all of these media. Alternatively, the user-generated content message may be an advertisement that may include a web link to complete an electronic commerce transaction and/or to provide additional information and promotional material associated with the advertiser's particular product or service.

### BRIEF DESCRIPTION OF THE DRAWINGS

FIG. 1 is a schematic illustration of the interconnection between representative hardware components of a system for displaying or performing user-generated content during programming being transmitted by a television channel or network.

FIGS. 2A and 2B are flow diagrams representing certain steps of a computer-implemented process for a system for displaying or performing user-generated content during programming being transmitted by a television channel or network.

FIG. 3 is an example of a web page interface for recording video for uploading to an online service for transmitting video on television or over the Internet on other services, such as social networks.

FIG. 4 is a flow diagram representing certain steps of a computer-implemented process for conducting an auction for time slots for user-generated content in connection with the process of FIGS. 2A and 2B and FIG. 5.

FIG. 5 illustrates a flow diagram for a ticker creation process.

FIG. 6A is an illustration of an example of a web page for an interface for an online ticker service.

FIG. 6B is an illustration of an example of a web page interface of an online ticker service.

FIG. 7 illustrates a process for creating a video blog with video that can be shared with other online services.

FIG. 8A is an example of a web page interface for an online video blog service with an option for adding advertisements to the blog.

FIG. 8B is an example of an interface for viewing video blogs created by a user.

FIG. 9 is an example of a web page interface of a virtual credit component for an online community.

FIGS. 10A and 10B are examples of interface for video mail through an online service associated with an online community.

FIG. 11 illustrates an example of a landing page for a Web site, through which several on-line services can be obtained.

FIGS. 12A and 12B are examples of an interface of an application running on a smart phone for accessing online services described in connection with FIGS. 2A, 2B, 3, 4, 5 and 7.

FIG. 13 illustrates a block diagram of basic components of a representative example of a processor-based, programmable computing system.

FIG. 14 is a graphical illustration of a linear programming timeline for a television network.

### DETAILED DESCRIPTION

In the following description, like numbers refer to like components.

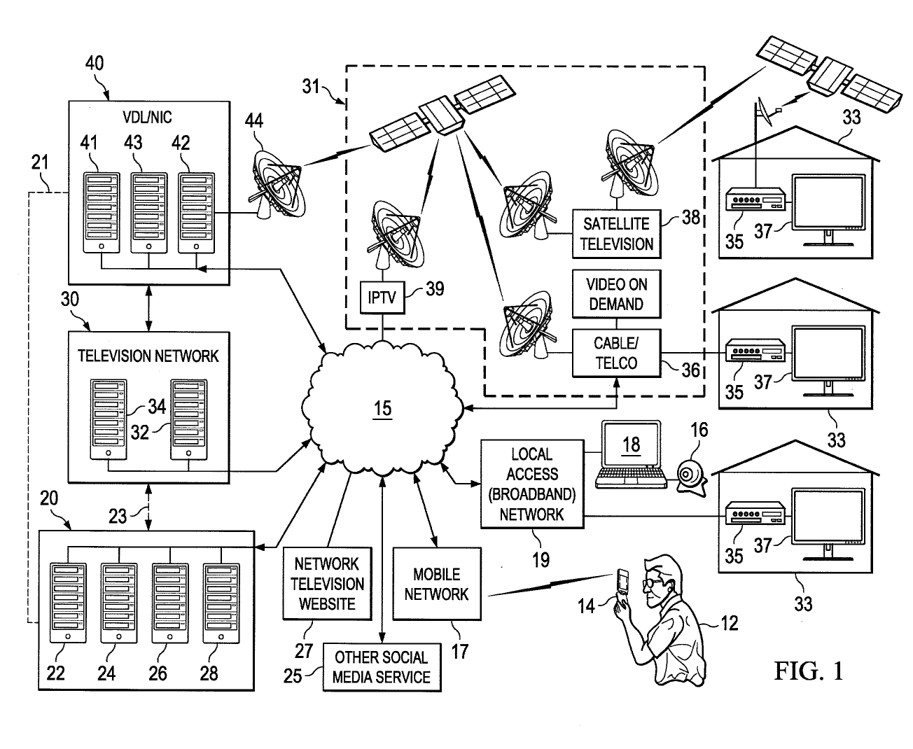

Referring to FIG. 1, user 12 communicates with a service provided by one or more servers 20 for user-generated content displayed during predetermined time slots during linear TV programming being transmitted by a television network. A user is, in one embodiment, an individual. However, in other embodiments, a user can be a group of individuals who are friends or part of a family, or part of a social group or organization, and it can be the group or formal organization. In another embodiment, the user can be a business or commercial enterprise.

In the following description, a “server” is a software program, or part therefore, running on a programmable computer that is providing certain services to other programs running on the same computer or on a remote computer. Each server is illustrated in FIG. 1 as running on a different processor-based computer system. In other words, each server is illustrated as a different computer. However, this is not intended to imply that each server must run on a separate computer. Rather, for example, two or more of the servers may execute on the same computing system, or on different virtual machines on the same computing hardware. Multiple computing machines could also host multiple instances of a server, depending on the needs and requirements of the particular implementation. Furthermore, two or more of the servers could be implemented as part of a single program being executed by a computer.

User 12 may use any suitable recording device to record video, audio and still images or photographs. For example, user 12 may use a camera 16 to record video. The user may also use a computer program to create graphics, animated graphics and text titles, and to edit video, photographs, graphics, animated graphics, text and audio into a single work. “User-generated content” refers to any type of visual content, for example, video, still images, graphics, animated graphics, or text, or combinations of them, either with or without audio. If the user-generated content contains something other than, or in addition to, video captured with a camera, the content is preferably rendered into one or more specified formats, preferably a video format, suitable for uploading and for conversion to a format used for transmitting linear television programming.

In one exemplary embodiment, user 12 operates a device, having at least an embedded computing system comprising a programmable processor and memory, to store the user-generated content and to upload it. The device could also be, but does not have to be, used to capture and record, and/or edit, the user-generated content. Such a device may also connect to a data network and communicate with a remote server over, for example, the Internet. Examples of such devices include not only desktop, laptop and tablet computers, and smart phones, each with or without video and/or still cameras, but also devices that have embedded processing systems, such as cameras with wireless interfaces for connecting to data or computer networks and embedded processors for executing programs for enabling communication over such networks and providing other enhanced functions.

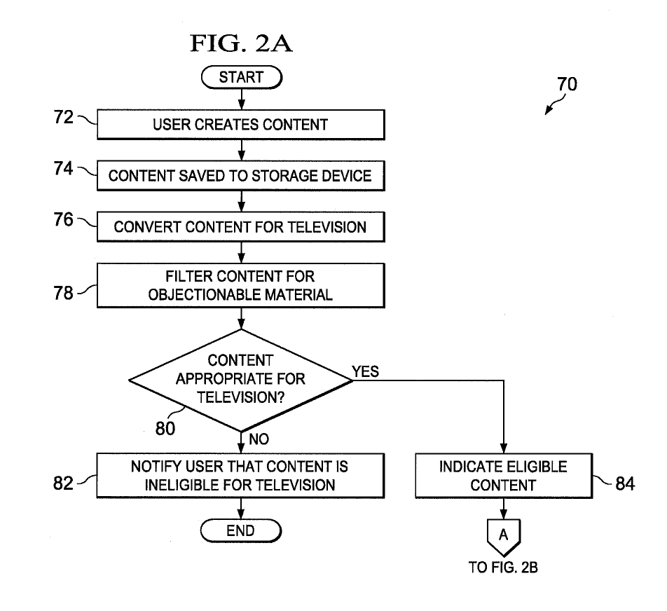

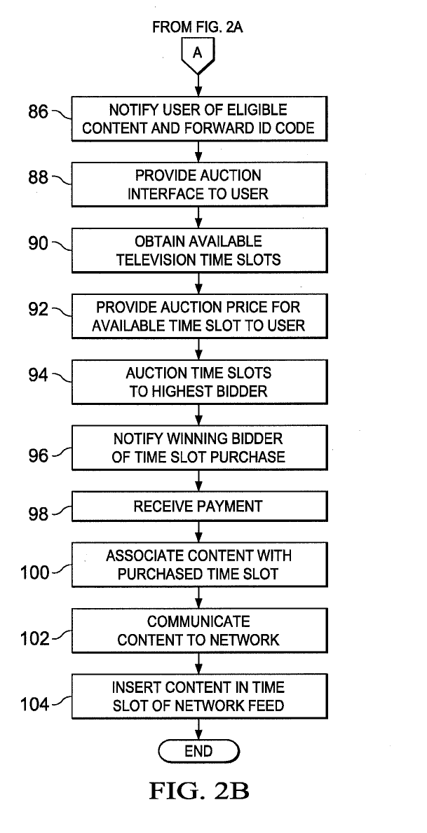

In FIG. 1, smart phone 14 and computer 18, to which video camera 16 is connected, are representative examples of such devices. Video camera 16 can also be built into the computer. User 12 creates video content with, for example, smart phone 14, camera 16, or a built-in camera on computer 18 and uses the smart phone 14 or computer 18 to communicate the user-generated content over one or more interconnected data networks to one of servers 20, which are programmed to provide an online service described in connection with FIGS. 2A, 2B, 3, 4 and 5. Servers 20 represent software processes running on one or more computers. In performing the processes, certain of these servers communicate with a network operations center 30 and/or an uplink facility 40, depending on the embodiment, either through Internet 15 or through one or more other networks or direct connections, as indicated by lines 21 and 23.

The network operations center 30 represents a collection of computer-implemented and other processes that are performed in connection with certain operations associated with a television network. These processes may run on computers at a single location or located at multiple locations. Furthermore, the uplink facility is a representative example of a facility or operations center from which a television network's signal or “feed” originates and is distributed to carriers who provide television services.

Internet 15 is an example of multiple communications networks interconnected to each other for enabling communication between any devices connected to any of the networks using, for example, a public network addressing scheme such as Internet Protocol (IP) addresses. In this example, smart phone 14 communicates over mobile network 17 and computer 18 communicates over local broadband access network 19, each of which is directly or indirectly connected with Internet 15 and provide Internet services. Examples of other types of local access networks, to which end points such as smart phone 14 and personal computer 18 can connect to communicate on the Internet include, without limitation and by way of example, dial-up and broadband wireless connections, and any other type of communication media, or any combination thereof. These access networks are directly or indirectly connected to Internet 15.

FIG. 1 is intended to be representative and not limited to, or to imply, any particular data networking topology or media.

A television network typically transmits one program at a time to its subscribers or audience over a predefined period of time and according to a predetermined schedule. This type of programming is called “linear programming.” The programs to be transmitted to the audience, and the schedule for transmitting of the programs, are usually planned in advance of the time of transmission to an audience. The programming schedule, usually expressed in the form of a programming grid, specifies what program and, if applicable, episode is to be transmitted on each day and at any given time during the periods in which the network is scheduled to transmit. Television programs can include, but are not limited to, television series, motion pictures, news programs, reality television programs, sporting events, and other audio/visual works. The programs are often pre-recorded. However, programs can be “live.” Generally, such programs are professionally produced. The network either owns or licenses the legal rights to distribute them.

Traditional linear programming is divided into thirty-minute or hour segments, though it can be divided into shorter or longer segments, depending on the need of the network. Programs can occupy more than one segment. Within a typical thirty-minute segment, for example, approximately twenty-four minutes is reserved for transmitting the program. The remaining time is divided between roughly three, two-minute segments or pods for commercials and/or other promotional announcements. Those segments or pods are typically subdivided into multiple time slots for sale to advertisers. The duration of the pod and each of the time slots can be chosen to be any desired length. The network transmits, or arranges for transmission of its signal so that the half-hour segments begin at the top and bottom of each hour. However, networks can and do sometimes adjust the start and end time of programs. A network may or may not transmit more than one signal, or “feed,” in order to account for time zone differences or other considerations.

For the most part, networks utilize what is called a programming server to schedule linear television programming. The programming server maintains a database that specifies the program, the episode, the date of transmission, and start and stop times of each. Even when a program is “live,” it is accounted for in the programming grid utilizing the programming system. The program server also typically includes additional information on each program, such as its title, describing the program so that it can be published in program guides, etc. In the example of FIG. 1, a network uses program server 32, located within its network operations center 30, for scheduling programs on that network. Networks that sell advertising will also typically operate or make use of a “traffic server,” such as traffic server 34 that is part of network operations center 30. The traffic server keeps track of time slots, called “insertion points,” within each scheduled TV program, that have been set aside for insertion of a prerecorded commercials, promotional spots and other announcements. Each such insertion may be referred to generically as an “ad spot” and collectively they are referred to as advertising “traffic.” The traffic server stores information about each time slot in one or more databases on one or more servers. This information will typically indicate whether a time slot, which is also called an “avail,” is available and, if it is taken, information about or identifying the advertiser, the amount to be charged when the commercial is aired, and other information. Although programs specially designed for the purpose of tracking advertising are typically used, the traffic search can be any type of computer database or software, or collection of them, that records this information.

The programming of a television network—the network's signal or feed—is typically distributed to viewers via one or more local broadcast television stations for local broadcast and/or one or more carriers for transmission on other mediums, such as cable TV systems, wired or wireless high-speed broadband networks, mobile data networks, satellite television systems, for substantially simultaneous viewing by multiple users.

A TV program to which a network has distribution rights could also be delivered “on demand,” meaning at the request of a viewer, in which case program transmission to that user begins at the request of a user and continues according to a predefined timeline. Such on-demand programs generally do not, but could, include predefined time slots within the timeline of the program for advertising, promotional announcements and other uses. However, transmission of such on-demand programming usually originates from the carrier, such as at the head end of a cable network, or from a server that streams the video over the Internet to the user requesting it.

Typically, a network's signal or feed is transmitted by, or on behalf of the network, distributed simultaneously to one or more TV carriers across some or all of a country or continent using a satellite transmission system. However, other transmission systems, or combinations of systems, can be used. A television network may own and operate its own uplink facility, or it may choose to contract with one or more third party uplink facilities, such as uplink facility 40 in the exemplary embodiment of FIG. 1, to transmit its signal up to a satellite for distribution to one or more local distribution systems 31. These television distribution systems, operated by carriers, receive the satellite signal and transmit it on their systems to subscribers, who are represented by homes 33, but can include any type of residence, as well as bars, restaurants, theatres and other commercial establishments. Each subscriber has, in this example, a set top box 35 or some other gateway or device that receives and decodes the signal so that it can be played on a television or monitor 37. The figure's representative examples include a television service offered over wired, terrestrial system 36, such as a cable television system or a cable-like television service provided over a telecommunication network system, such as the Verizon FiOS® or AT&T U-VERSE® services, and a satellite television system 38, such as DirectTV.

Other types of distribution systems exist or could be used for transmitting a network's “live” feed to subscribers, including IP television services, which use the Internet protocols and packet-switched networking architectures to carry the signal to subscribers. The television signal or feed generated by broadcast server 42, is, for example, transmitted to an IP television service provider 39 through the uplink or, alternately, a private network or other connection. The IP television service provider would then send out that signal as a “live” stream over the Internet 15, or possibly also private data networks to subscribers who have a set top box 35 connected to the server through, for example, local access network 19, which provides Internet services to the subscriber. Local broadband access network 19 is representative of any type of local access network that provides access to the Internet to end users, including fixed wired, fixed wireless, and mobile wireless networks, including those that might also provide television services, such as cable and telecommunication networks.

The uplink, represented by satellite transmitter 44 in the example, is connected to broadcast server 42, which represents one or more servers and/or other automated equipment that is used in connection with creating or generating a linear programming feed or television signal that will be transmitted to the carriers. The broadcast server assembles the program and the spots into a continuous linear signal according to a schedule shared by program server 41 and the insertion points specified in the traffic server 43. This process is referred to as “playout.” Electronic copies of the programs and spots are sent by mail (on physical media, such as tape) or over a computer network (by email, FTP or other process) to the uplink facility, which stores them on one or more storage devices in communication with the broadcast, program and/or traffic servers and the uplink facility. The electronic files or media containing the copies of programs are associated to records within the program server. Similarly, one or more electronic files or media containing a copy of each spot is associated with a record in the traffic server for a time slot. A particular time slot for insertion of a commercial or promotional spot will have assigned to it a unique identifier that can be used to reference that time slot.

In the illustrated example, the network operations center 30 and the uplink facility 40 each maintain a program server and a traffic server for reliability. Program schedule and traffic information on the uplink facility's sewers are updated with information from network's program server 32 and traffic server 34. However, a single instance of each server, or more than two instances could be maintained.

Referring now also to FIGS. 2A, 2B, in addition to FIG. 1, flow chart 70 illustrates a representative process for receiving and processing user-created or user-generated content for transmission by a network one or more of its television signals or feeds. This process is, in the illustrated embodiment, one of the on-line services provided by servers 20.

The process of flow chart 70 is performed by, in the illustrated embodiment, servers 20. Each server stores program instructions for causing the servers to execute one or more parts of the process. Collectively, the servers provide, through execution of process 70, as well as additional processes described below, online services to users through, for example, a web browser or client side application, server side application or mobile application. In the case of a web browser, an interactive web page that functions as an interface is generated and sent by a web server. In the case of a client application running on a programmable device, such as computer 18, smart phone 14, or another device with an embedded processor, the application generates an interactive interface through which the user can receive, view, and send data or information in order to make use of the services. The application communicates through an application programming interface available through a remote connection to one or more of the servers 20 to send and receive data.

Services provided by process 70, as well as other processes described herein, by servers 20, can also be made accessible through third party web sites maintained on remote servers, such as social media site 25 or website 27 for a television network, through, for example, an application programming interface to one or more of the servers, or a referral to, for example, a privately-labeled web interface hosted by one or more of servers 20.

As indicated by step 72, the user 12 creates or generates content and, at step 74, it is received and stored by one or more of the servers 20 when the user uploads it through a user interface. In the present example, storage server 28 acts as a storage device in communication with the other servers. However, any type of storage system can be used for storing the user generated content.

As previously mentioned, the user 12 may use any suitable recording device to record video and other user-generated content for upload. The user could also edit the video and create other content and then render it in one of one or more predetermined video formats.

In one embodiment, the user-generated content has a duration that approximates that of typical television commercials or advertisements, for example, fifteen seconds, thirty seconds, sixty seconds or one-hundred twenty seconds. In another embodiment, the user may create a program of a length that is standard for a television program, such as a conventional half-hour television program. The content created by the user could also be, but does not need to be, a professionally produced video created by a group of like-minded individuals that want to communicate a common message. For example, a group or organization may produce a promotional video and employ process 70 to have that video transmitted to a national television audience over a television network as scheduled programming.

In one embodiment, the user need only register by providing, for example, basic information such as a user name and an email address. However, less information could be provided if desired. The registration can be validated through an email sent to the provided email address or by a text message sent to a phone number. Alternatively, registration need not be required. User 12 may, optionally, be required to supply additional identifying and other personal information through the online interface or client application in order to create a profile. The user profile is created and populated with the received information by one of the servers 20, and is stored in one or more databases hosted on, for example, storage server 28. Registration can be done in advance or contemporaneously with uploading a video. A registered user or agent allows the service to identify user 12 in future interactions. If the user already has been registered or has a profile, the user is authenticated, if desired, using a password or other type of authentication mechanism in connection with uploading of the video file.

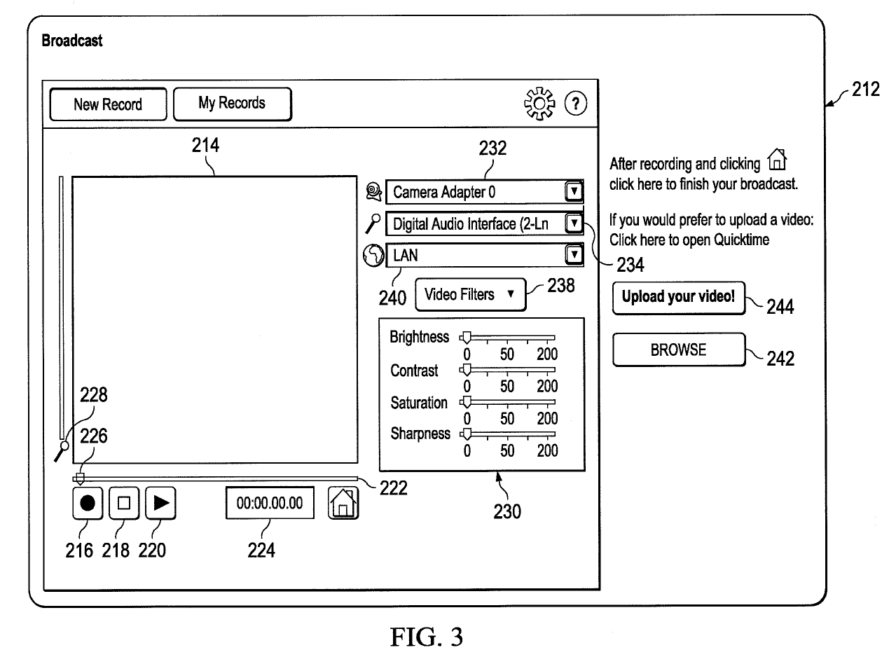

Turning briefly to FIG. 3, illustrated is a representative example of an interface in the form of a web page 212 generated by web server 22 for display on a computer or other user device with a programmable processor running a web browser, that can be used to record video from a camera connected, wired or wirelessly, to the computer and/or upload video. In this example, it is being used to record and to upload video for transmission on a television network. The video being captured by the video camera is shown in window 214. Selecting buttons 216, 218 and 220 starts recording, stops recording, and plays back what has been recorded. Time bar 222 and display 224 indicate the length of the recording and slider 226 indicates the position within the recorded video of the currently displayed frame. Moving the slider will forward and rewind the video. Zoom slider 228 allows the user to zoom in and out, permitting the user to crop the video while it is being recorded. Brightness, contrast, saturation and sharpness can also be controlled and set by a user using a group of sliders 230. Video and audio inputs from which the video and audio recorded are selected using drop down menus 232 and 234. Predefined filters can be applied by selecting one from drop down box 238. A previously recorded video can be selected by clicking on the “Browse” button 242 and selecting a file using a file selection dialog. Once that video file is selected, it can be played back in window 214. Once the video is ready for uploading, “upload your video” button 244 is selected, which transfers the video to web server 28 (FIG. 1) or other server specified in the programming of the interface. In the example of FIG. 1, the file is stored on storage server 28 and associated with the user's profile stored in a database on storage server 28.

In connection with the uploading, the user is, in one embodiment, also required to submit through the user interface additional information about the user-generated video, such as a title. The user may also be asked to provide and/or certify authorship, originality, and other production-related information. This information, when received by web server 22, is stored by one or more of the servers 20, for example in a database on storage server 28.

Returning now to FIGS. 2A and 2B, when the user-generated content is received by servers 20, it is associated with the user's profile. The user created content is converted, if necessary, into a format suitable for use in generating a television signal for transmission by the television network at step 76 by a process running on transcoding server 26. In one embodiment, the format of the user-generated content is converted, if necessary, to a digital video file format that is suitable for use by broadcast server 42 in generating the one or more television signals or feeds that are transmitted to the carriers of the network. Multiple versions of the user-generated content might need to be made if different formats are required for transmission to different carriers or over multiple distribution mediums. The converted file or files are associated with the user 12 through, for example, the user profile.

At step 78, the user-generated content is filtered or checked for compliance with legal requirements and other requirements (for example, editorial and qualitative) set by the television network. In one embodiment, the filtering process is an automated process. For example, step 78 may include employing a software program that filters or screens for copyrighted material, objectionable text or images, and requirements for length. The filtering may be performed by an individual that views the content for copyright and other issues, profanity, other adult-themed content or other content that may not be suitable for transmission over the given television network. The manual screening process is optional and may be performed in addition to, or instead of, an automated filtering. The eligibility criteria can be, if desired, made dependent on the television network, the program, the time of day and/or day during which the user-generated content might be shown on the television network.

At step 80, if the video passes the filters, the user video is, optionally, screened by a person to determine if the content is appropriate for viewing on the network or during the program or time of day it might be viewed. If the filtering is manual, the filtering and screening can be performed, if desired, by the same person.

If the content is determined to be unsuitable, either by use of filtering using automated or manual routine, or by manual screening that occurs after filtering, for use on a television program, the user is notified that the content is ineligible for broadcasting at step 82. The notification may be in the form of an electronic mail message that is sent to an address for an email, text messaging, chat or other communications service specified in the user's profile. In other embodiments, the notification may be by pop-up error message in a web interface or any other suitable means of communicating with the user 12.

If the content is determined to be appropriate or eligible for television, then the content is identified as broadcast eligible at step 84. In one exemplary embodiment, the identification may be an indication in a database with the user's profile information, or in another database, that the content is eligible. In another embodiment, tags or data may be appended to be inserted into the file containing the user-generated content to indicate that the video is eligible. At step 86, the user 12 is notified that the submitted content is eligible for broadcasting. This notification can be an optional step. In addition, an identification code may be generated and, optionally, made available to the user 12 through an interface to the service. This identification code may be used by user 12 to communicate to the system 20 that the content submitted by user 12 is eligible for broadcasting and further processing by the system 20. The unique user identification code may also be used by the processes executing on servers 20 to associate the user 12 with a file that has been converted and passes the filtering and screening processes.

Beginning with step 88, the process allows a user to select one or more time slots for transmission of eligible user-generated content on the television network. The transmission may be conditioned upon receipt from the user of some type of acceptable consideration. However, the time slot may also be given, without exchange of consideration, to a user for promotional purposes. In one embodiment, one or more available time slots are made available to more than one user, and those users are given the opportunity to request the time slot. If the right to a time slot is to be given in exchange for consideration, the user to receive it can be selected through, for example, an auction process in which the user with the highest bid is selected, subject to any reserve or other conditions. If it is to be given away without payment of consideration, some other process can be used to select the user, such as a contest. In another embodiment a time slot can be purchased for an advertised amount. The embodiments can also be combined. If the time slot is not given to the user, any form of consideration can be accepted as payment for a time slot. Examples of types of payments include any type of real currency, credits or point that have been accumulated by the user, which are forms of virtual currency, or some other form of virtual currency that might have been purchased or otherwise earned by the user in connection with, for example, using an online service.

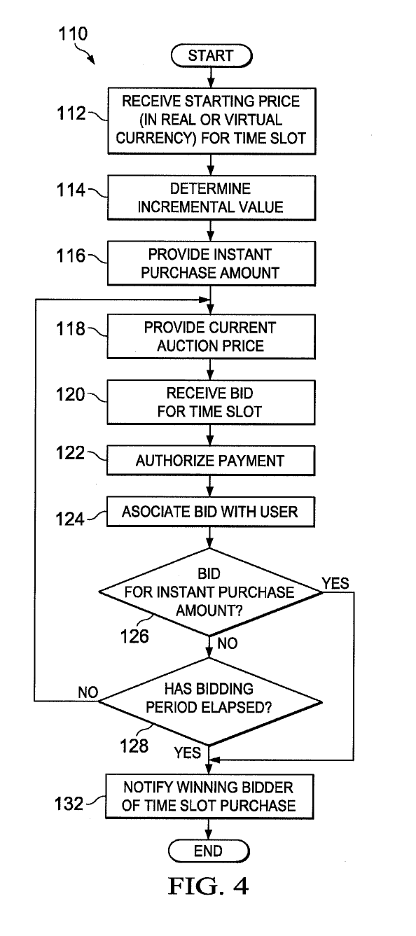

The user 12 is, at step 88, presented with an interface with which to pay for, or otherwise elect to use any right they may have, to show the user-generated content during a predetermined time slot on a television network. In this example, the interface is an interface to an auction process that will be described in connection with FIG. 4. However, the interface could allow, or give an option for, the time slot to be purchased without going through an auction. The interface is, for example, generated by web server 22, communicating with auction server 24, and sent to a web browser running on the user's computing device 14 or 18. Alternatively, a local application running on the user's device, communicating with, for example, the web server or auction server 24, generates the interface on the user's device using data provided by the action server or web server. To specify the user generated content to be transmitted, the user 12 may enter the unique user identification code forwarded to him in step 86 into an auction interface to access auction server 24 to allow the user 12 to participate in an auction process. Alternately, the auction server may access the one or more databases maintained by the online service 20 to determine whether the user, based on the user's credentials, has a user-generated content eligible for showing on television (or at least for a particular network, program, time and/or day). The auction may proceed according to the process shown in FIG. 4, which is described below.

At step 90, time slots available for user-generated content are obtained from the television network. For example, in one embodiment, the available time slots within one or more network programs are obtained by querying the traffic control server 32 or a file or database generated from the traffic control server of available slots. In the illustrated example, the auction server 24 obtains the available time slots by establishing a connection with, for example, the traffic control server 32 or other server having access to information on available time slots.

The television network typically establishes or defines time slots during a scheduled program that are to be sold or used for commercials. For example, time slots designated for commercials or advertisements that are available for user generated content can be those to which a commercial, promotional announcement or user-generated content, for example, have not been assigned or, if assigned, are available to be replaced by user-generated content under certain, predetermined conditions. However, a television network may chose to limit further the commercial time slots available for user-generated content to only certain ones or to those meeting predetermined criteria.

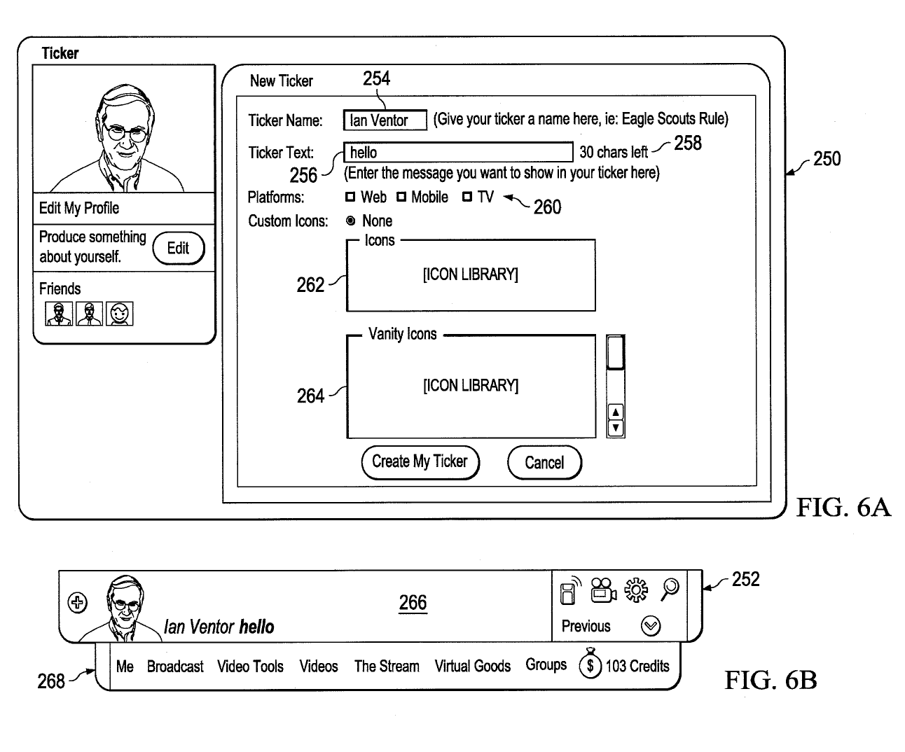

In another embodiment the television network might create time slots specifically designated for user content. FIG. 15 illustrates a representative timeline for linear programming of a television network featuring a segment of affinity programming, meaning a program targeting a particular affinity group. In this example, user-generated content is inserted in time slots 91 labeled “SB,” which are short segments called “bumpers” that immediately precede and follow segments 93 a television program. The program can be edited to create the SB time slots without sacrificing time slots 95, labeled “Ads,” normally reserved for commercials. However, user generated content could also be inserted into the Ads time slots. A television network might also offer the opportunity to purchase or otherwise obtain the right to display a text message and/or graphic from the user on the lower third of the screen during a program and/or social bumper, generally represented as “lower third texting” 96 of FIG. 15. The text messages could be displayed, for example, in the form of a ticker moving across the screen. In another embodiment, the ticker can be selectively shown contemporaneously on the television and on a web page or smart phone application (see, for example, FIG. 6B).

The information about the available time slots obtained during step 90 may include, for example, only general information about a portfolio of time slots that are available, such as the number of slots, their lengths and a general time frame during which they occur, without any specific day, time period or program for each slot. However, in an exemplary embodiment, it may include additional information, for example one or more of the following: the program in which the time slot occurs; the specific episode of the program; the time of day, (e.g. afternoon or a time period from 1 PM to 5 PM); the time slot for the program (e.g. 2:00 PM to 2:30 PM); the day of week and/or date; and possibly where in the program the available time slot is.

In addition to the available time slots, auction server 24 may obtain the duration for those time slots. Durations may be fifteen, thirty, sixty, ninety or one-hundred twenty second segments, or another predetermined length. A unique identifier is generated by the traffic server 32 and assigned to each time slot. This identifier will be used, in the exemplary embodiment, by the traffic sever and broadcast server 42 to associate the user-generated content of the user with the purchased time slot.

Other details that may be obtained are information on the program being televised and a predetermined sales price associated with a particular time slot. A sales price for a time slot may vary with respect to the time slot's duration, associated program, time of day and the like. The sales price may be a price that a commercial advertiser is willing to pay to be able to broadcast its commercial advertisement during the same particular time slot. An auction reserve price can be set, for example, based on the price or other information provided by the traffic server. In the exemplary embodiment, it is set at a premium over a price at which the slot would be sold to a commercial advertiser. In the event that a time slot is not auctioned for the reserved price, the time slot can be sold to a commercial advertiser through a conventional sales process. If the auction price exceeds the reserve price, then the time slot is auctioned to the user submitting the highest bid. In this manner, a market with a minimum reserve price may be created for commercial time slots.

If an auction process is being used, a reserve or instant purchase price and possibly other information is set or determined. The price and other information can be determined or set based on information from the television network's traffic server about the time slot is provided at step 92 to the user 12 through, for example, an auction interface (web or client application). This information can be limited to merely the availability of a time slot for user-generated content, or it could include details about one or more of day of week, date, a time period or program during which the user generated content would be transmitted. However, in an alternative embodiment, the information need not include reserve price or an instant purchase price.

Although not indicated, the process may also qualify the user prior to bidding or purchasing the time slot based on the program, time or day of the time slot, or be based on information about the user contained in the user's profile information. For example, the process may require that the user provide a form of payment, for example a credit card. An authorization request is made and, if approved, the user is permitted to participate in the auction process. Other qualifying or limiting criteria can also be used. If a television program is targeting a particular affinity group, for example an organization like the Boy Scouts of America, the bidding or purchasing of a time slot during that program may be limited to members of that affinity group, or a different pricing or payment mechanism (for example, some form of credits earned through the organization or other means) might be used. The price that is displayed to the user can be either a fixed price at which the time slot can be purchased or the current bid price (or reserve price if no bids have been received).

At step 94, an interface through which solicitations for the time slot can be received is presented to the user. In the illustrated example, auction server 24 communicates information for the user interface to the users' devices, receives solicitations for a time slot from users' devices, and awards or assigns the time slot to a user. The solicitations from users may take the form of bids or offers to purchase a time slot, using real or virtual currency, from one or more users who have previously submitted content determined to be eligible. In alternative embodiments, for example those in which the time slot is given away for promotional reasons, the solicitations take the form of some type of request, including, for example, an entry into a contest. Each time slot that is made available to a user is, in the case of an auction, awarded to the highest bidder at step 94, provided that the bid meets any predetermined conditions, such as being equal to or in excess of a reserve price, or it can be sold, for example, to someone offering to pay an “instant purchase” amount. An example of an auction process is a process shown at FIG. 4. The user to whom the time slot will be awarded, if any, is selected and, at step 96, the person to whom the time slot awarded or assigned, such as the winning bidder or purchaser in the case of a time slot being sold or auctioned used using real or virtual currency, and the user that is otherwise selected to receive the time slot, is notified through a user's interface. The notification may be similar to that described with respect to notifying the user that the user-generated content is eligible for broadcasting at step 86.

At step 98, settlement of the purchase occurs if it is to “paid” for using some for consideration, such as money or a virtual currency. For payments using a real currency, for example, a user's credit card is charged, or the user pays through some sort of payment service. If it is virtual currency, including points or credits, the amount is deducted from the user's account. If the time slot is awarded for promotional purposes, the step can be skipped.

The content of a user, such as user 12, who purchases or is otherwise assigned a time slot, is associated at step 100 by one of the servers 20, for example, storage server 28, with a time slot being auctioned or offered for sale. Storage server 28 provides storage for files or databases and other information associated with the online services provided by servers 20. The unique code generated by traffic server 32 for the time slot can be used to make the association.

At step 102, information about the user-generated content is provided by one of the servers 20, for example storage server 28, to traffic server 32 in the network operations center 30, for delivery to the uplink facility. Alternately, it can be provided directly to the uplink facility. Once transmitted to the uplink facility, this information is stored in the traffic server 43 of the uplink facility.

At step 104 the user-generated content is inserted into the linear programming in the time slot assigned to, or associated with, the user. As previously mentioned, the broadcast server 42 represents one or more systems, typically automated, for generating a feed or signal containing the linear programming that will be transmitted to carriers. The information can be stored in metadata files or tags associated with the user-generated content. The unique identifier generated by the traffic server for the time slot allows the information to be associated with the time slot. Depending on the timing of the auction, the transmission control server will likely have already obtained traffic information—information about the insertion points for advertising into programming and additional information about commercials that will be inserted—from the traffic server 32, including the unique identifier for the time slot purchased by the user. In this case, the additional information about the user-generated content can also be provided directly to the uplink facility, in particular traffic server 43 or broadcast server 42.

In this example, broadcast server 42 uses information from the program and traffic servers maintained by the uplink facility, labeled 41 and 43, respectively, to assemble at step 104 the linear programming for the television network from the files containing the program, advertising and user-generated content. An example of such linear programming is illustrated by FIG. 15. The video files for the programs, the advertising, and the user-generated content, are stored at the uplink facility 40 by, for example, program server 41 and the traffic server 42, or at a location that can be reliably accessed during playout.

For example, the user-generated content may be communicated electronically from storage server 28 to program server 32 or other storage server that will store the user-generated content using a file transfer protocol. In other embodiments, the user-generated content may be copied from storage server 28 to a physical storage medium that may be delivered physically to a facility operated by the television network, such a network operations facility 30, or to the facility that will playout the linear program, for example uplink facility 40. In yet another embodiment, the file with the user-generated content may be communicated electronically to the broadcast server 42. The unique identifier assigned to the time slot by the traffic server 32 is used by the broadcast server 42 to associate the user-generated content with the time slot in which it is to be televised.

In the foregoing embodiments the linear programming is distributed by a television network on a national level. However, the services could be provided on a regional or market level. For transmission systems in which addressable transmissions are possible, an alternate embodiment inserts user-generated content based on predetermined addresses, such as addresses known to be associated with a particular geographic area or with members of a particular group or organization of like-minded people. This embodiment can be adapted for either linear programming or an on-demand model. The embodiment can be adapted to allow for distribution over a single high-power television in a single market, or for the addition of another television network on a single (or multiple) cable television carrier within a single market.

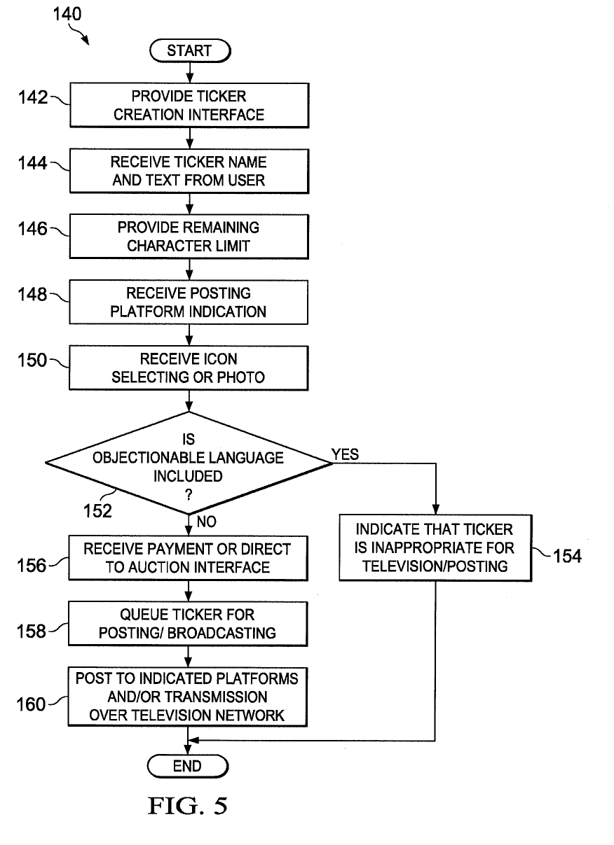

Assuming the time slot is to be exchanged for some form of consideration, such as payment using a real or virtual currency, and not given away for promotional purposes, FIG. 4 is a flow diagram of an example of an auction process 110 for the process of FIGS. 2A-2B and the ticker process of FIG. 5. The auction process 110 begins at step 112 where a starting price (denominated in real and/or virtual currency) for a time slot is received by auction server 24 from traffic server 32. As previously stated, the starting price received from traffic server 32, can be a reserve price for which an advertiser has previously agreed to pay for the right to broadcast a commercial during the same time slot, At step 114, an incremental value may be determined. The incremental value may be a multiple or fraction of a multiple greater than current value of the starting or reserve price. When added to the starting price, the current auction price may be determined. The current auction price may be the determined additional percentage over the starting price. This may allow the auction to generate additional value for each time slot.

At step 116, an instant purchase amount may be provided. The instant purchase amount may be a multiple over the starting price. In certain embodiments, the time slot may not be available for instant purchase and may only be auctioned. If an instant purchase amount is available, a bidder may purchase the time slot by bidding the instant purchase amount. Once a bid for the instant purchase amount is received, the time slot will be reserved for that bidder's content without receiving any additional bids.

Once the auction server 24 computes the starting price, incremental value, and an instant purchase amount, the current auction price may be determined and provided to the bidder. At step 120, the auction server 24 may receive a bid for the time slot. The bid may be any amount the bidder chooses or the current auction price. In other embodiments, the bid may be required to increase in pre-determined increments.

Once the bid is received, then payment by the bidder may be authorized. It may be advantageous to authorize payment once the bid is received, even though the bidder may ultimately not win the auction and thus not be required to pay for the time slot. Nevertheless, assurance that the bidder is able and authorized to pay for the time slot reduces problems that may arise if a winning bidder is ultimately unable to pay for the time slot. Payment authorization may be by conventional credit card payment authorization or other payment method.

At step 124, the unique bid offered by the user 12 may be associated with that particular user 12 and the content generated by that user. This association may be accomplished through an entry in a database, metadata tags, or other suitable method. At step 126, a determination of whether the bid is for the instant purchase amount may be made. If the bid is for the instant purchase amount, then the winning bidder may be notified of the time slot purchase at step 132. If the bid is not for the instant purchase amount, then a determination whether the bidding period has elapsed may be made at step 128. This determination may be made continuously throughout the bidding period, such that once the bidding period elapses, the bidder with the highest bid at that time may be notified of the purchase of the time slot at step 132. If the bidding period has not elapsed, then the auction price may be incremented at step 130. In certain embodiments, there may be no increment to the auction price, but rather bidders may be allowed to bid any value over the current auction price. The process returns to step 118 where the current auction price is provided. The user or bidder may be provided the information or data to allow participation in the auction process through the auction interface that the user accesses through the personal computer 18, the smart phone 14, or any other web-enabled device associated with the user 12 or other bidder.

Referring now to FIG. 5, illustrated is a flow diagram 140 for an embodiment of a ticker creation process of a ticker service that is part of the on line services that is offered to an online social network community hosted by servers 20. The ticker service is hosted by, in this example, one or more servers. Although not expressly indicated, the ticker service can be implemented in part by web server 22 (FIG. 1), for example. Publication of the ticker can be handled by the web server or another server or process. The ticker may be placed, for example, in a window on web pages generated for a web site of an online service, such as those described herein or other social network service, or one a web site of a community, group or organization. The ticker may also appear on a portion of a television screen during the broadcast of a linear or on demand television program or commercial. It may appear on any one, any combination, or all three of the above-mentioned mediums independently or synchronously. A ticker may include a text message, an associated logo vanity item or photo, and a ticker name. Tickers may be used to allow an individual or group to communicate a message to web users, users of a particular social network or other website, or a national television audience. Tickers may also be associated with a good or service that a manufacturer/provider wishes to advertise. For example, a ticker may advertise a sale price on athletic shoes by a particular athletic shoe retailer or manufacturer.

At step 142, a ticker creation interface is provided by the ticker server to the user 12. The interface can be, for example, a web-based interface or generated by a client application on a device such a smart phone with an embedded processor. FIG. 6A is an example of a web-based ticker creating interface 250 generated by a web server, for example web server 22 (FIG. 1), for display by a web browser running on, for example, computer 18 that is in communication with the web server. At the user interface, the user may provide a name and text for the user's ticker at step 144. The user enters in fields 254 and 256 (FIG. 6A) a ticker name and the text of the ticker. At step 146, the user may be provided by field 258 an indication of the remaining characters left to use for his ticker message.

At step 148, a posting platform indication is made by the user and is sent to and received by the ticker service. The user may indicate through, for example, check boxes 260 (FIG. 6A) what platform he wishes his ticker to be available on. For example, the user may indicate that he wishes his ticker to be posted on the web, on mobile devices, or on television. The user may select any one, any combination, or all three of the platforms. In another embodiment, the user could also be given the option for displaying the ticker on video screens at sporting events or other highly-traffical public or private venues such as a sports arena.

At step 150, an icon selection may be selected using windows 262 and 264 of the interface 250 (FIG. 6A) and the selection sent to and received by the ticker service. Icon window 262 is populated with previously created icons from an icon library. These icons can be, for example, icons provided by or associated with a group or organization with which the online service is associated. A vanity icon library populates window 264. By selecting these icons, which might be logos for various products and services, the user can signal an affinity for that product or service. The user may, in another embodiment, also choose to associate the ticker with a photograph of the user or some other photograph image a user may select and upload.

At step 152, it is determined whether objectionable language or inappropriate references, inferences are included in the ticker name or ticker text. This may be accomplished through an automatic text filter that can search the ticker text and ticker name for words, characters, and the like that have been predetermined to be objectionable. If it is determined that objectionable material is included in the ticker name or ticker text, then an indication that the ticker is inappropriate for broadcasting or posting is made. The indication may be in the form of an electronic mail message, an error message that appears on the web page interface, or other suitable notification method. If it is determined that objectionable material is not included, then payment for posting or broadcasting the ticker may be made. In an alternate embodiment, the user may be directed to an auction interface and proceed with an auction according to the steps outlined in FIG. 4 in order to buy the right to post or broadcast his ticker message.

In certain embodiments, the auction may be associated with the right to broadcast the ticker with a particular program that may be targeted to a particular audience, whereas the web and mobile platforms for the ticker may not distinguish for a particular audience. In an alternate embodiment, a user 12 may also indicate a particular group to post the ticker to, such that the particular group's online community may view the ticker.

At step 158, the ticker is queued by the ticker service for posting on the platforms selected by the user. At step 160, the ticker may be posted to the web or the mobile devices. The ticker may also be transmitted to a television audience as a lower-third ticker displayed during a television program.

FIG. 6B is an example of a window 252 that appears on one or more web pages served by each user of a web site of, for example, an organization, group, or on-line service, including social networking services. This window is created by web server 22, using information from the ticker server. Ticker messages from users are scrolled in window 266. Each ticker includes a ticker name and a ticker text and, optionally, one or more icons selected by the user and/or a photograph of the user. The ticker interface can also include links 268 to other services or interfaces available to the user of the web site or online service that is displaying the ticker. When a user 12 clicks a hyper-link associated with a particular ticker, the user 12 may be provided with information that the user 12 may use to receive the published discount. In certain embodiments, advertisements are also shown on the ticker. In, for example, a smart phone application for the online service, the ticker service can insert a barcode or other indicator that, when scanned at the point-of-sale, may authorize a discount. A particular ticker may be accessible over the user platforms for a predetermined length of time. The duration of time that the ticker is displayed may be based on purchase price of the ticker or any other suitable criteria.

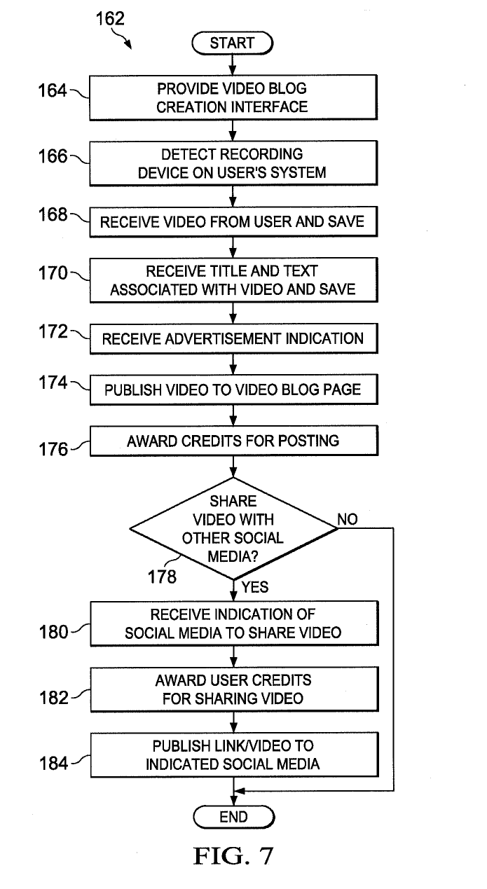

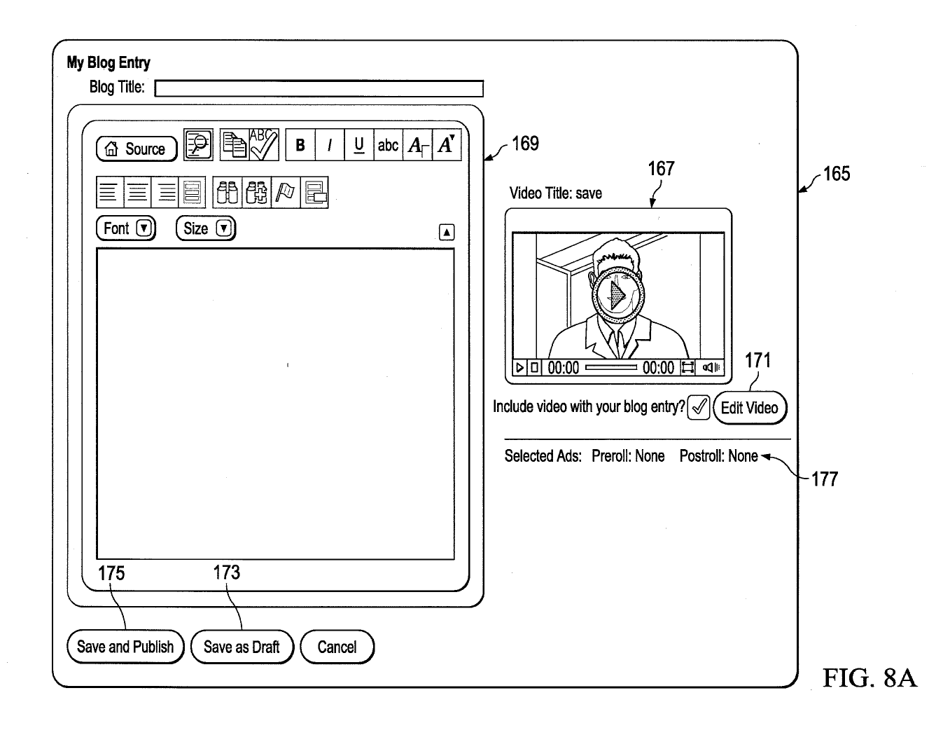

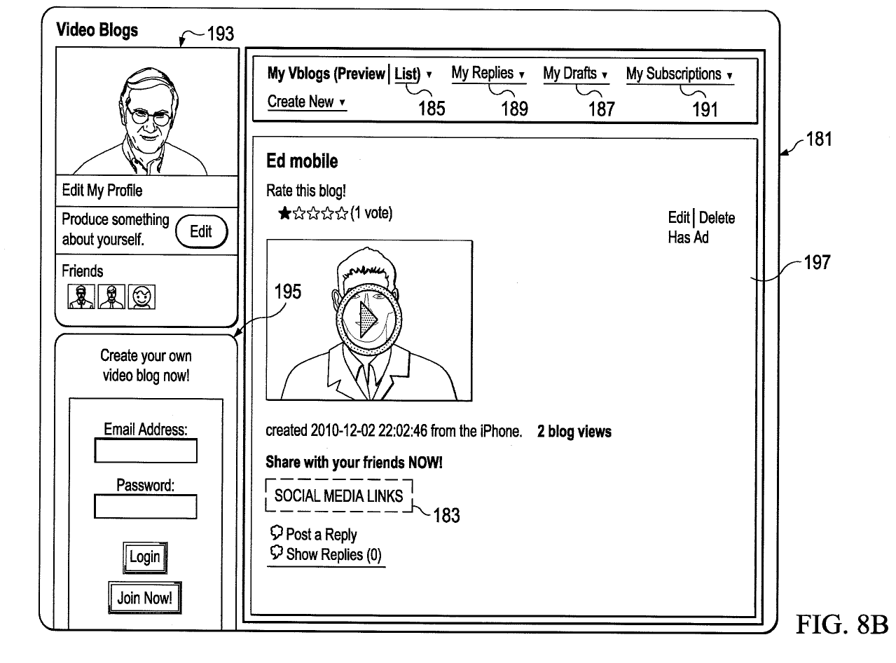

FIG. 7 illustrates a flow diagram of a representative embodiment of a process 162 for providing an on-line video blog service, in which a video is published as part of a web blog or a user. In this example, the video blog service is part of the online service that includes the service for publishing user-generated content to television of FIGS. 2A and 2B, and the television ticker service of FIG. 5. As such the process is, for example, implemented by servers 20, as part of an on-line social network service that they represent collectively. Process 162 will be described in further reference to FIG. 1. The process of FIG. 7 will be also described in further reference to FIGS. 8A and 8B. FIGS. 8A and 8B illustrate, respectively, an example video blog creation interface for a user of the online service and an example of an interface for managing the video blogs of the user. Each is generated by, for example, web server 22 of FIG. 1 for use by user 12 on computer 18.

Referring first to FIGS. 1, 7 and 8A, the representative process 162 begins at step 164 where a video blog creation interface is provided. At step 166, one or more camera devices 16 (FIG. 1) associated with personal computer 18 or smart phone 14 are detected and, if present, the video is displayed in window 167 (FIG. 8A). This functionality may allow a user to create a video quickly and easily that may then be published or otherwise distributed to an audience indicated by the user. The user creates the recorded video through the interface. Alternately, the user can be permitted to attach a prerecorded video. Edit button 171 (FIG. 8A) allows the video to be edited after it is recorded in an editing interface, which is not shown. The user may also add accompanying text for posing with the video. Video blog creation interface includes a text editing window 169 (FIG. 8A) and give the blog entry and video titles.

When finished the user saves the blog, with the video, as either a draft, by selecting button 173 (FIG. 8A), or for publication by selecting button 175 (FIG. 8A). When the blog entry is saved, a server, such as web server 22 (FIG. 1), receives from the interface at step 168 and 170 the blog entry, including the title, text and video file. These are stored, for example, on storage server 28 (FIG. 1). The video server may be implemented on one of the services 20 (FIG. 1) or in a database or storage device that can store video and permit the file for the video to be associated with the user's record.

In addition, at step 172, (FIG. 7) an advertisement indication may also be received by the servers 20. The user may be given the option of selecting, using part 177 of the interface, a previously created advertisement to be displayed each time the video is played after the blog entry is published. The user can be given an incentive to include an advertisement, such as credits that can be used toward a purchase, such as the purchase of a time slot in linear programming of a television network. The selected advertisement may run immediately before or after the video blog is viewed. These advertisements are referred to in the interface as “pre-role” or “post-role” advertisements. Both pre-roll and post-role advertisements can be selected. The user may also be enabled to select “interstitial” advertisements, meaning an advertisement that runs part way into the blog, or an advertisement that is overlayed with a portion of the video when played. Alternately, the on line video blog service may insert or embed one or more advertisements without the user receiving option to select an advertisement.

If the user indicates that the blog is to be published, such as by selecting button 175, the blog, including the video, is published by a video blog server at step 174, so that it can be viewed by others. The video blog server, which can be running on one of the computers on which servers 20 are running, or hosted elsewhere, handles the publication of the video blog page. The same server or a separate server can host the videos and steam them for playback. The same or yet another server can automatically insert advertisements into the video, based on the user's selection, either prior to or when the video is streamed to a user for viewing. Alternately, the server can select and insert an advertisement at the time the video is streamed based on predetermined criteria (such as who is viewing) or can insert an advertisement selected or specified by the video blog service.

At step 176 the service gives to the user credits for posting a video blog to the video blog page. Credits are a form of virtual currency for which users can pay for certain services, such as for purchasing (either directly or through an auction) of a time slot during a television program of a user-generated video or publication on television of a ticker.

A server, such as web server 28 (FIG. 1), publishes the video blog using a web interface on the Internet for others to view the video blog. The stories or entries on a video blog can be distributed in other ways, such as through an RSS feed or could also be accessed using client applications, such as one running on a smart phone.

Referring now to FIGS. 7 and 8B, the web interface 181 illustrated by FIG. 8B is presented to a user of the video blog service to view video blogs and to manage draft and published video blogs. It is presented to the user, for example, after the user uploads a video or when the user logs into or accesses his or her account on the video blog service. Through this interface a user can share the video blog by selecting one more social media links, which are generally indicated by dashed box 183. Current examples of such social media services include MySpace®, Facebook®, and Twitter®. If, as indicated by steps 178 and 180, the user has indicated that the video is to be shared using another service to which content or links to content can be posted or shared, the user is awarded additional credits for sharing the video at step 182. At step 184, the video blog service accesses the user's account on one or more selected services, using information previously provided by the user and the other service's application programming interface, to share the video blog entry.

Through interface 181 (FIG. 8B) a user can also view, edit and delete his or her video blog entries, and entries in other video blogs, and manage subscriptions to other video blogs. Window 183 displays a currently selected video blog, as well as the average rating given to the entry by viewers, and includes links to view replies, post replies (when viewing another user's entry), Drop down list 185 allows the user to select other of his or her published entries for viewing. Drop down list 187 allows a user to select saved drafts. Drop down list 189 allows a user to view comments made by the user to video blogs of others and drop down list 191 allows the user to view video blogs of others to which he or she subscribes. The user's profile is shown in window 193, and is viewable by others. The same interface can be used by users who are not registered with the video blog service or who are not logged in, though without several of the features available. Window 195 allows a user to login into or create an account.

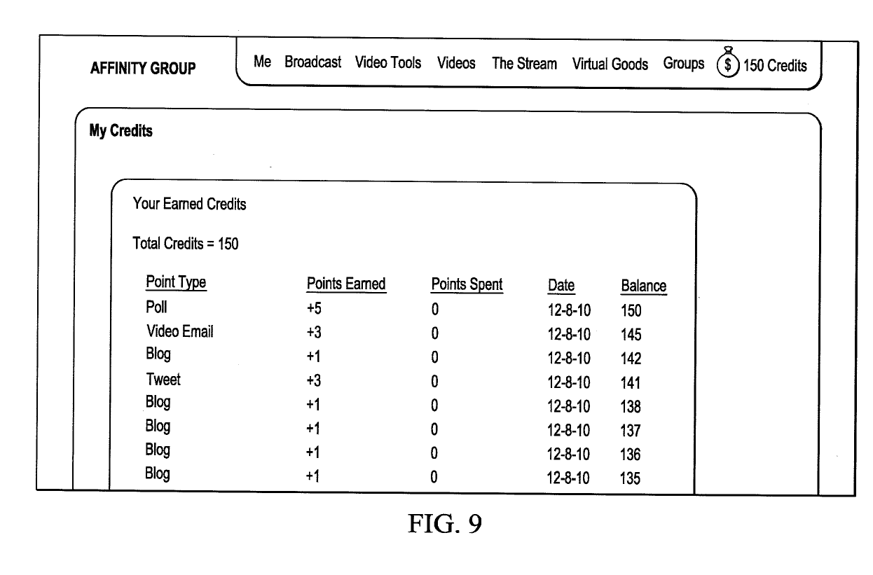

Referring to FIG. 9, illustrated is an example of a web page generated by, for example, the online services provided by servers 20 (FIG. 1) displaying virtual credits earned through, for example, posting video blogs, sharing video blogs, sending video mail, and participating in other services

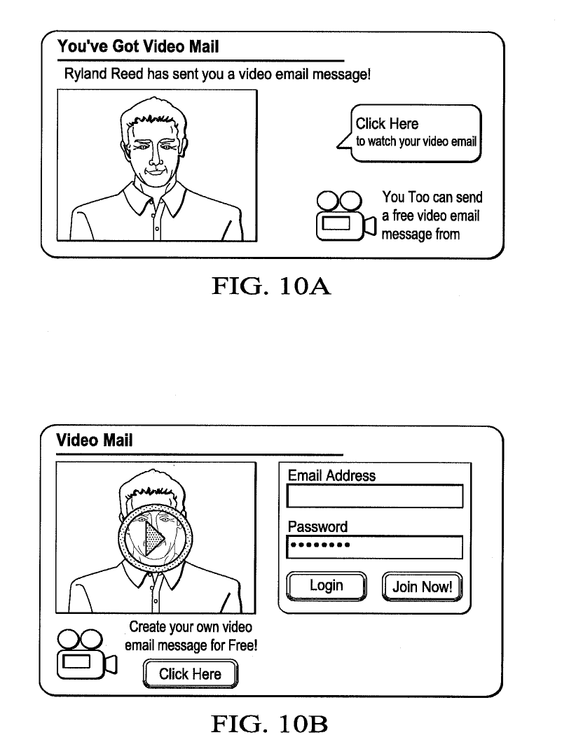

Referring to FIGS. 10A and 10B, a user of the video blog service may also share a video with others through electronic mail communication. Although not indicted in the FIGS. 7, 8A and 8B, email can be another service through which the video blog entry can be shared. FIG. 10A is an example of such a video email. The email includes a link that, when clicked, takes the user to, for example, the interface shown in FIG. 10B, where the user can click on the video to watch it. Both the email and the video viewing interface can include a link that takes the user to a video mail creating interface or to a web page to sign up for the video blog service. Alternately, the video may be embedded in the message or attached to the message. The video could include, for example, advertisements, as described above in connection with FIGS. 7 and 8A. A mail server, which can be included in the services 20 (FIG. 1), generates the email and forwards it to the recipient's email server. The user needs to provide the email address of the recipient, if the user is not registered with the video blog service or other online service associated with the video blog service. Otherwise, if the recipient is a user of the service, the service can use the email address that the user provided.

The services provided through the execution of the computer process illustrated in FIGS. 2A, 2B, 4 and 7 can be provided as separate services, or two or more of the services can be provided as part of an online social network or community. In alternate embodiments, the online community can be limited to a particular group or organization. Furthermore, an affinity online community, through which online service providing services such as those provided by the automated, online process of FIGS. 2A and 2B, can be associated with affinity programming on one or more television networks, such that services for transmitting video and displaying text messages generated by users who are members of that community are tailored to that community. For example, such services could be limited to particular affinity programming, special pricing, privileges or credits could be automatically provided to members who use services.

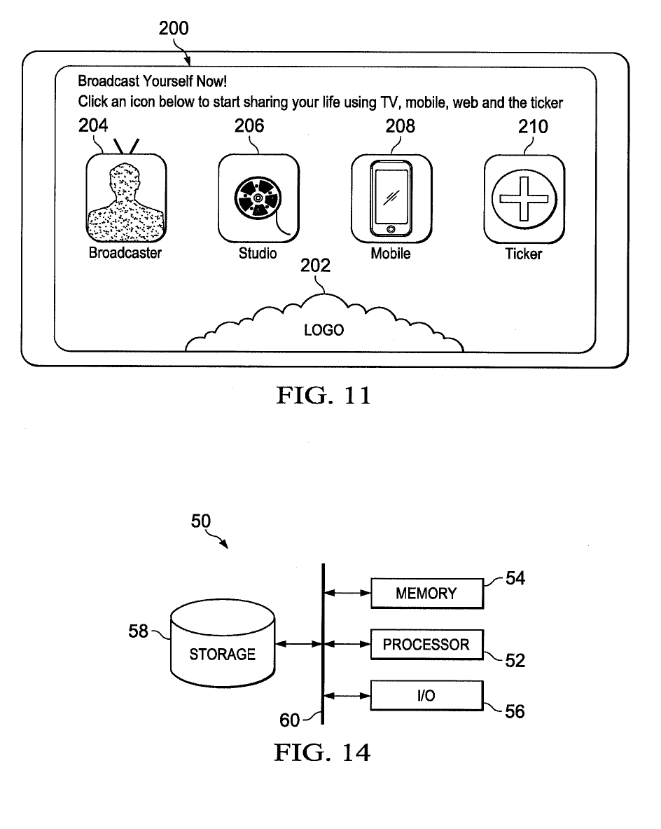

FIG. 11 is an example of a web page 200 that was displayed within a web browser on a computer of a user, generated by web server 22 and sent to a user in order to access online services. From this Web page, the user can select to publish an online video or ticker according to the processes described above in connection with FIGS. 2A-2B and 5, respectively. In this example, the web page is part of a website—for example, a web site for a social networking site or a television network—that is privately labeled or branded for an organization, as indicated by logo 202. Clicking on button 204 launches process 70 of FIGS. 2A and 2B. Clicking on button 206 launches a browser-based video editing tool, with which a user can edit a video for upload in a format suitable for transmission on a television network, publication on and streaming from a web site, or emailing. Clicking on button 208 makes additional on-line tools available to the user for managing mobile use of the services. Selecting button 210 begins the process described in connection with FIG. 5.

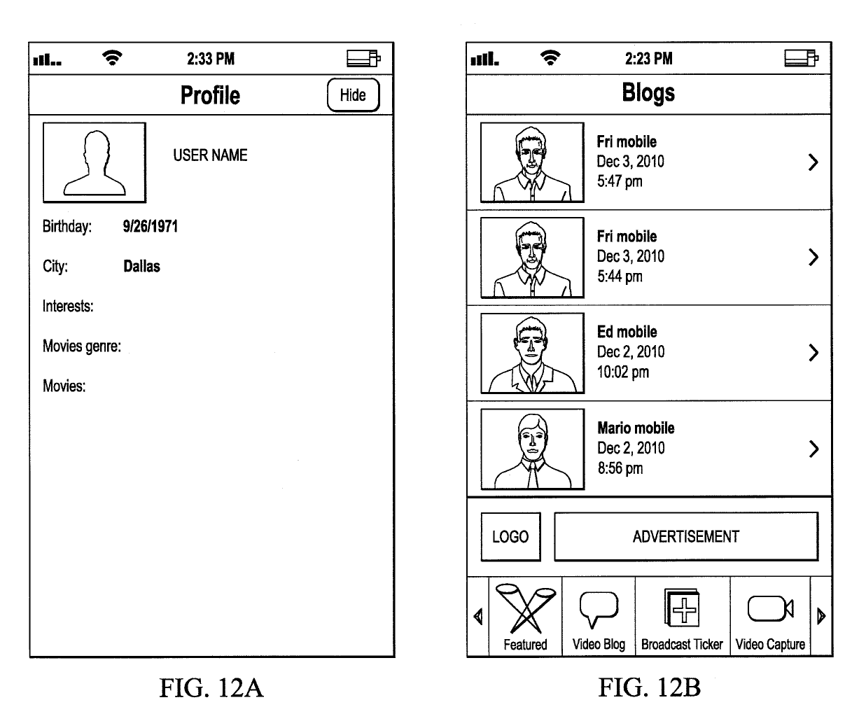

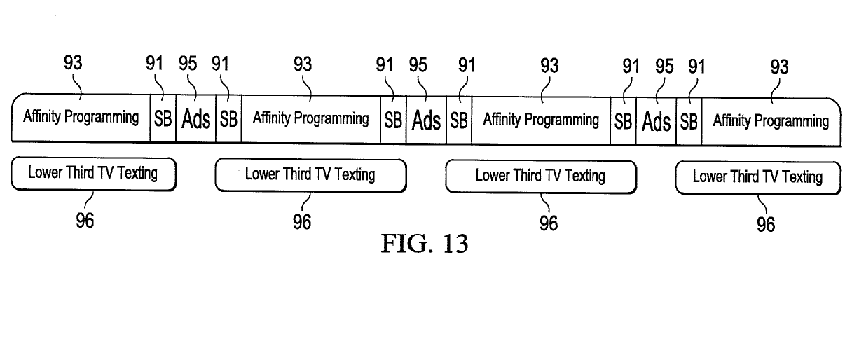

FIGS. 12A and 12B are examples of interfaces of a client application on a smart phone or table computer for displaying, respectively, a user profile and a list of video blogs to which a user subscribes. In these examples, the client interface also includes a button for selecting related services, such as a ticker service, as described in connection with FIG. 5, an interface for recording video for transmission on television, as described in connection with FIGS. 2A and 2B, or other content featured by the online networking service with which the application is being used.

FIG. 14 illustrates a block diagram of basic components of a representative example of a processor-based, programmable computing system 50, such as a server computer, personal computer, laptop computer, or an embedded processor of a smart phone, camera, television, set top box or other device. In order to implement the processes represented by the flow diagrams of FIGS. 2A, 2B, 4 and 7, a computing system is specially programmed by software instructions that, when executed by one or more processors, performs or causes performance of at least the operations or functions described in the figures.

In computing system 50, there are one or more processors, which are represented by processing entity 52, and working memory 54, in which program instructions are loaded for execution by processing entity 52. These instructions can also be stored or contained on any type of electronic, optical or magnetic media, as well as on transient signals, sent to the computing system, that can be read by the computing system. The instructions, which may first need to be compiled, are loaded into the memory 54 for execution by the processor. Examples of such media include mass data storage and removable media. Information and data on which the process acts, as well as resulting from operations of the processing entity 52, are stored in memory 54.

The system also includes an input/output subsystem 56, which is representative of one or more subsystems through which the computing system may interact with a user or may communicate with other computing systems by transmitting information using signals. Examples of the one or more subsystems include a display, a user input device, such as a keyboard, mouse, touch pad, touch screen, or remote gesture recognition device, through which a user may interact with the program, and interfaces for communicating with other computing systems or devices. Storage system 58 is intended to be representative of any type of system for storing data including program instructions before being loaded into memory for execution and data of any type. Typically, the data will be contained within files, and the storage system organized into one or more volumes with one or more directories. Examples of the types of data that is stored by storage system 58 comprise, without limitation, resources used for generating web pages, including graphics, scripts, and other code; user profiles; user-generated content; and databases storing information being used or generated by the processes. The storage system 58 is illustrated as being local, communicating over bus 60 with the processor 52 and memory 54. The storage system 58 may be embodied in a local hard drive, for example. However, it could also be located on a mass data storage device located elsewhere on a local or wide area network, or on a remote server.

No particular computer architecture is intended to be implied by this example. The example is intended to be representative generally of computing systems suitable for being programmed to perform these processes, and not limiting. Execution of a process need not be limited to a single computing system, but could be distributed among more than one computing system. Programs running on a computing system or on multiple computing systems execute parts of the process described in the flow diagrams of FIGS. 2A, 2B, 3, 4 and 5. Multiple instances of a process may execute on the same or on multiple different computing systems. Instances of each of the servers 22, 24, 26 and 28 could run on the same computer, or on different virtual machines on the same computer.

The foregoing description is of exemplary and preferred embodiments. The invention, as defined by the appended claims, is not limited to the described embodiments. Alterations and modifications to the disclosed embodiments may be made without departing from the invention. The meaning of the terms used in the claims are, unless expressly stated otherwise, intended to have ordinary and customary meaning and are not intended to be limited to the details of the illustrated structures or the disclosed embodiments.

1-28. (canceled)

29. A method performed by data processing apparatus, the method comprising:
receiving video data from a client computing device associated with a particular user, wherein the video data is captured using a camera communicably coupled to the client computing device and using controls displayed through a recording user interface provided to the client computing device;
receiving, from the particular user, a request to publish the video data as a video blog;
receiving an identification of a source of consideration for publishing the video blog from the particular user; and
publishing the video blog by storing the video data on a server from which third parties can retrieve and view the video data.

30. The method of claim 29 wherein the video data is received by a video blog management server further associated with a service for publishing videos in a linear television programming transmission.

31. The method of claim 29 wherein the video data is received by a video blog management server further associated with a service for publishing textual messages on at least one of a web page or a television broadcast.

32. The method of claim 29 wherein the recording user interface is provided to the client computing device in a web page received from a server.

33. The method of claim 29 wherein the particular user is associated with a user account stored on a server system, the method further comprising associating the received video data with the user account on the server system.

34. The method of claim 33 further comprising crediting virtual currency to the user account for publishing the video blog.

35. The method of claim 34 wherein the virtual currency can be used to purchase time slots for publishing video or textual messages within a linear television programming transmission.

36. The method of claim 33 further comprising publishing the video blog through one or more social media services.

37. The method of claim 36 further comprising providing a video blog management user interface from the server system through which the particular user can select one or more of a plurality of social media services through which the video blog is published.

38. The method of claim 37 wherein the server system accesses the one or more selected social media services through an application programming interface associated with each of the social media services using information associated with the user account on the server system.

39. The method of claim 33 further comprising providing a video blog management user interface for managing video blogs associated with the particular user through the user account.

40. The method of claim 39 further comprising providing access through the video blog management user interface to an editing interface for editing the video data.

41. The method of claim 33 wherein the recording user interface is provided by a client application stored on the client computing device, wherein the client application further accesses the user account on the server system to facilitate viewing previously recorded video blogs.

42. The method of claim 29 wherein the identification of the source of consideration includes an advertisement selected by the particular user.

43. The method of claim 29 wherein the video blog is stored on a server for retrieval through at least one of a web interface, an RSS feed, or a client application on a user device.

44. A system comprising:
a user device; and
one or more servers operable to interact with the user device and to:
receive video data from the user device, wherein the video data is associated with a user account defined on the one or more servers and the video data is captured using a camera connected to the user device using controls displayed through a recording user interface displayed on the user device;
provide the user device with access to the user account to perform editing of the video data, request publishing of the video data as a video blog, and receive identification of consideration for publishing the video blog; and
publish the video blog for retrieval and viewing through a web interface by third parties.

45. The system of claim 44 wherein the one or more servers are further adapted to publish videos as part of a linear television programming transmission.

46. The system of claim 44 wherein the one or more servers are further adapted to credit virtual currency to the user account for publishing the video blog, the virtual currency allowing purchase of time slots for publishing video or textual messages within a linear television programming transmission.

47. The system of claim 44 wherein the one or more servers are further adapted to publish textual messages on at least one of a web page or a television broadcast.

48. The system of claim 44 wherein the recording user interface is provided to the user device in a web page received from the one or more servers.

49. The system of claim 44 wherein the recording user interface is provided on the user device through an application installed on the user device.

50. The system of claim 49 wherein the application further provides a user interface for viewing previously recorded video blogs.

51. The system of claim 44 wherein the one or more servers are further adapted to provide a web page including a video blog management user interface for managing video blogs associated with the user account.

52. The system of claim 44 wherein the one or more servers are further adapted to:
interact with a plurality of user devices;
receive video data from the plurality of user devices wherein the video data received from each user device is associated with one of a plurality of user accounts defined on the one or more servers;
provide each of the user devices with access to the respective user accounts to perform editing of the respective video data, request publishing of the respective video data as a corresponding video blog, and receive identification of consideration for publishing the respective video blog; and
publish the video blogs for retrieval and viewing through web interfaces by third parties.

53. A system comprising:
a user device; and
one or more servers operable to interact with the user device and to:
receive video data from the user device, wherein the video data is associated with a user account defined on the one or more servers and the video data is captured using a camera connected to the user device using controls displayed through a recording user interface displayed on the user device;
provide the user device with access to the user account to request publishing of the video data as a video blog and receive identification of one or more of a plurality of social media services associated with the user account; and
publish the video blog for retrieval and viewing through a web interface by third parties.

54. The system of claim 53 wherein the one or more servers are further adapted to access the plurality of social media services through an application programming interface associated with each of the social media services using information associated with the user account.
